(19) United States
(12) Patent Application Publication
(10) Pub. No.: US 2024/0342617 A1
(43) Pub. Date: Oct. 17, 2024

(54) SYSTEMS AND METHODS FOR THE USE OF VIDEO GAME CHARACTERS STORED IN A CHARACTER DATABASE

(71) Applicant: MYTHREAL INC., Phoenix, AZ (US)

(72) Inventors: Brandon Welner, Phoenix, AZ (US); Julian Beuzieron, Thousand Oaks, CA (US); Tyler Cheswick, Phoenix, AZ (US)

(73) Assignee: MYTHREAL INC., Phoenix, AZ (US)

(21) Appl. No.: 18/627,704

(22) Filed: Apr. 5, 2024

Related U.S. Application Data
(60) Provisional application No. 63/496,328, filed on Apr. 14, 2023.

(51) Int. Cl. A63F 13/79; A63F 13/35; G06Q 20/36

(52) U.S. Cl. CPC A63F 13/79; A63F 13/35; G06Q 20/36

(57) ABSTRACT

Systems and methods for the use of video game characters stored in a character database are discussed herein. A character server receives, from a user computer system, a character identifier corresponding to a character stored at the character server and an asserted owner identifier corresponding to the character identifier. The character as stored at the character server may include data regarding one or more character attributes of the character that is applicable within a scenario with which the character may be used. The character server then verifies that an owner of the character corresponds to the asserted owner identifier. Finally, the character server communicates, between the character server and the user computer system, the one or more character attributes of the character based on the verification that the owner of the character corresponds to the asserted owner identifier.

### CROSS-REFERENCE TO RELATED APPLICATION

This application claims priority to U.S. Provisional Application No. 63/496,328, filed Apr. 14, 2023. The aforementioned application is incorporated herein by reference, in its entirety, for any purpose.

### TECHNICAL FIELD

This application relates generally to the organization and use of video game characters that are compatible with multiple differing scenarios of a gameplay application.

### BACKGROUND

In various existing gameplay applications for video games, a video game character (herein sometimes referred to more simply as a “character”) may be created and/or used. Such a character may be controlled or otherwise operated by the user as they make their way through a scenario of a gameplay application designed for use with the character.

With respect to typical video game systems, a character may be created for use within a scenario that has been created by a developer of the gameplay application for the scenario. In some such cases, the character is created with attributes applicable to/intended for that particular scenario of that particular gameplay application. These attributes may define, for example, the ability and/or the extent to which the character may engage with various aspects of the scenario. In typical video game systems, such characters are not designed in such a way as to be useable within/transportable to other scenarios.

Further, because of the tight relationship between a character and the corresponding scenario, it may be that the character is stored/provisioned in such a way that is only functionally coherent with respect to a particular instance of the gameplay application that provides the scenario intended for the character.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system for the creation and use of video game characters stored in a character database, according to embodiments discussed herein.

FIG. 2 illustrates a system for the creation and use of video game characters stored in a character database, according to embodiments discussed herein.

FIG. 3 illustrates a method of a character server, according to embodiments discussed herein.

FIG. 4 is a schematic diagram of a computing system which may be used to implement various embodiments in the examples described herein.

### DETAILED DESCRIPTION

Herein, systems and methods for using characters compatible with a variety of differing scenarios are discussed. In one example, a method for creating and accessing a character across multiple video games or scenarios is disclosed. For example, a user can select and/or build/modify a character and during game play may retrieve the character for use within the specific scenario, e.g., retrieve from a database. In this manner, character attributes (e.g., skills) can be used across a variety of scenarios and optionally character attributes that are achieved in a first scenario can be applied in a second scenario, allowing users to have full functionality and the benefit of their character development. This character may be used across different platforms, different gameplay applications, and the like. Further, in some instances, users can transfer (e.g., sell) characters, which may allow certain users to play with higher skilled characters than otherwise would be possible.

In some implementations, a gameplay application is designed to selectively operate various different scenarios may be developed (e.g., by developers of the gameplay application and/or by non-developer users of the gameplay application). The various scenarios may, in some cases, be made available on a purchasable basis in a scenario marketplace.

The various scenarios may be developed for the gameplay application in such a way that the incoming expectations with respect to a character to be operated in each scenario use the same definitions. For example, a first scenario and a second scenario (no matter the source) may be expected to be able to be played with arbitrary characters having character attributes (sometimes referred to herein more simply as “attributes”) that are defined in a certain way and/or within certain parameters. Consistency of character definition across scenarios may cause, for example, characters compatible with one scenario operated with the gameplay application to be compatible with other scenarios operated by the gameplay application.

Examples of attributes of a character may include, but are not limited to, a strength attribute, an intelligence attribute, a proficiency attribute with regards to one or more items or skills, etc. Further, in some cases, attributes about the status of other attributes (e.g., an attribute regarding an initialization state for one or more other attributes, a progress/growth level associated with another attribute) may also be understood/recorded as character attributes.

As created, the various scenarios may differ in various ways. For example, a first scenario may have first goal(s), a first setting, a first storyline, first non-player character(s) (NPCs) that interact with a character operated by a user, first item(s) that may be used by the character within the scenario, etc. A second scenario may have second goal(s), a second setting, a second storyline, second NPC(s) that interact with a character operated by a user, second item(s) that may be used by the character within the scenario, etc. that are each different than those from the first scenario.

In some embodiments, a first scenario and a second scenario may be operable within the context of a same gameplay application. For example, the first scenario and the second scenario may be individual levels of the same gameplay application. In other embodiments, the first scenario may be operable with a first gameplay application, while the second scenario may be operable with a second gameplay application (e.g., where the first scenario is not compatible with the second gameplay application and/or where the second scenario is note compatible with the first gameplay application).

Further, it is contemplated that various different scenarios may apply the character attributes for the characters in differing contextual ways. For example, in a first scenario, a dexterity attribute of a character may control a character's proficiency with a weapon, while in a second scenario, the dexterity attribute of the character may instead control the character's proficiency at creating an item. This may be so either within the context of a same gameplay application that operates the two scenarios or in the case where a first gameplay application operates the first scenario while a second gameplay application operates the second scenario. It is contemplated that the various scenarios may be played simultaneously by more than one character. Accordingly, description herein should be understood to apply to each (of potentially multiple) individual character(s) that may be used with respect to an in-progress scenario being operated by the gameplay application. Such additional characters may in at least some cases be controlled by different users, each using their own user computer system. In such cases, one or more of the users of such characters may connect with the gameplay application as hosted over a network.

Within such circumstances, systems and methods as described herein may be used to provision and/or manage available characters for use across the various available scenarios useable by the gameplay application. It is contemplated that a character may be stored on a character server for characters having character attributes arranged for scenarios of a gameplay application. A user at a user computer system may provide the character server (e.g., through a front end application) with a character identifier corresponding to a character stored at the character server and an asserted owner identifier corresponding to the character identifier. The character server may then verify that that an owner of the character corresponds to the asserted owner identifier (thereby ensuring that the user is authorized to use the character). Finally, communications between the character server and the user computer system may be performed that include the one or more character attributes of the character based on the verification that the owner of the character corresponds to the asserted owner identifier.

In some contexts, the one or more character attributes communicated to the user computer system may indicate or include that the character has not yet been initialized (e.g., the character attributes may not yet be set or may not yet be modified per the user's preference, and/or there may be a character attribute that explicitly indicates an initialization state of the character). In such cases, the user may proceed to initialize or set the character attributes at the character server (e.g., through an intermediary system useable for this purpose).

Note that in some cases, a character's attributes may instead be randomly and automatically initialized at the character server when the character is first created at the server.

In some contexts, the one or more character attributes communicated to the user computer system may include character attributes that were previously established. For example, the character attributes may reflect (at least in part) values for such attributes that were set during a user's prior initialization of the character, in addition to reflecting any changes that may have resulted to date though the prior use of the character through one or more scenarios of the gameplay application (as will be described further herein).

The character attributes as received at the user computer system may then be used by a present/current instance of the gameplay application (e.g., on the user's computer system or with which the user is interacting with over a network).

The use of the character server to save characters for use with the gameplay application brings various advantages. For example, it may be that as a user plays through a first scenario of the gameplay application, the character's attributes may change (e.g., based on things such as an experience level imputed to the character and/or a character attribute via the use of the character/character attribute to perform tasks of the scenario, story decisions that the user instructs the character to make during the scenario, etc.). As the character's attributes change, the new status of these attributes may be saved back to the character as stored on the character server.

Then, when playing a second scenario, it may be that an application programming interface (API) call from the gameplay application to the character server may pull in the character (having the attributes as modified from use in the first scenario) into a second scenario of the gameplay application.

This process may be repeated as between an arbitrary number of scenarios (of whatever source). Accordingly, the user's experience is improved, as they are able to further identify with the character as they use it (and see its character attributes progress) through multiple scenarios (as opposed to having to create and subsequently identify with a new character for each new scenario).

In some contexts, information regarding a users' ownership/control of characters as stored in the character server may be made publicly available through the use of character tokens corresponding to each character on the character server. For example, such tokens may be non-fungible tokens (NFTs) that individually represent one character of the character server and for which ownership/control may be recordable using a blockchain application. In such circumstances, the blockchain system may record the most recent association of the character token with a wallet that operates with respect to the blockchain system. Accordingly, the ownership/control of a character may be verified at the character server by checking with the blockchain system whether a wallet owned/controlled by a current user (e.g., that is requesting the use of the character from the character server) is the wallet that has the character token corresponding to that character (e.g., in the manner that is further described herein).

The blockchain system used to publicly record and control ownership of character tokens may also allow for the transfer of ownership/control of the token from one user to another. This may be accomplished, for example, through the users executing a smart contract on the blockchain system that updates the association of the character token from the wallet of the old owner/controller of the character to the wallet of the new owner/controller of the character.

In some such circumstances, a smart contract may be further configured to provide the old user with some other asset in exchange for ownership/control of the character token for the desired character. Such functionality can increase value of the characters to the users. Leveraging this smart contract functionality, a dynamic marketplace for the buying and selling of ownership/control of various characters of the character database may be enabled.

In other contexts, information regarding a users' ownership/control of characters as stored in the character server may be available as data retrievable from the character server itself. In such cases, user credentials (e.g., a username and password) may be associated with the ownership/control of a character as stored at the character server. Accordingly, ownership/control of a character may be verified at the character server by checking credentials provided by the user.

In some such circumstances, the character server may be configured to allow for the transfer of a character from one user to another user. For example, the original user for a character may specify the new user of the character (e.g., using the username of the new user of the character) to the character server to effectuate the transfer of the character to the new user. One or more payment systems may operate with/alongside the character server, such that this transfer may be configured to occur with/on condition of the transfer of some other asset from the new user to the original user. Such functionality can increase value of the characters to the users. Leveraging this payment functionality, a dynamic marketplace for the buying and selling of ownership/control of various characters of the character database may be enabled.

In some such circumstances, it is contemplated that an administrator could instruct the character server to effectuate the transfer of the character from an original user of the character to a new user of the character (e.g., in cases where manual character transfers are called for).

In some embodiments, a system for the creation and use of video game characters (e.g., via the use of a character database as described herein) may be managed by an administrator (e.g., a user operating an administrator computer system or with administrative access). The administrator computer system may provide one or more commands to a character server to instruct the character server to perform one or more tasks. For example, an administrator computer system may send to the character server an instruction to create a character, to store a character, to retrieve a character, to modify a character, etc.

In some embodiments, the character server may operate in conjunction with a service front end system operating a front end application. The front end application may, for example, be a publicly accessible network service that can perform one or more tasks related to the operation and use of the character database. For example, the front end application may perform tasks such as: performing communications with the character server to cause a new character to be created (e.g., in conjunction with a character provisioning process occurring between the front end application and a user computer system); performing communications with the character server to enable a user to initialize or modify a character of the character database; operating with a marketplace application configured to enable the transfer of ownership/control of a character token as recorded by blockchain application; enable the purchasing, accessing, and/or distribution of scenarios for the gameplay application; and/or hosting one or more instances of the gameplay application that can be connected to over a network by one or more users.

In some embodiments, once a user is verified as the owner/operator of a character stored at the character server (e.g., via correct credentials or once it has been verified that the character token/wallet correspondence recorded at the blockchain application indicates that the wallet owned/controlled by the user computer system is the wallet for that character token), the user computer system may send, to the character server, an instruction to communicate a character/one or more character attributes of the character to a gameplay application operating a scenario in which the user would like to play the character. The character server may send this data to the gameplay application accordingly. In some such cases, the gameplay application to which the character/character attributes are sent may be present on the user computer system, while in other such cases, the gameplay application to which the character/character attributes may be present on a system that is separate from each of the user computer system and the character server.

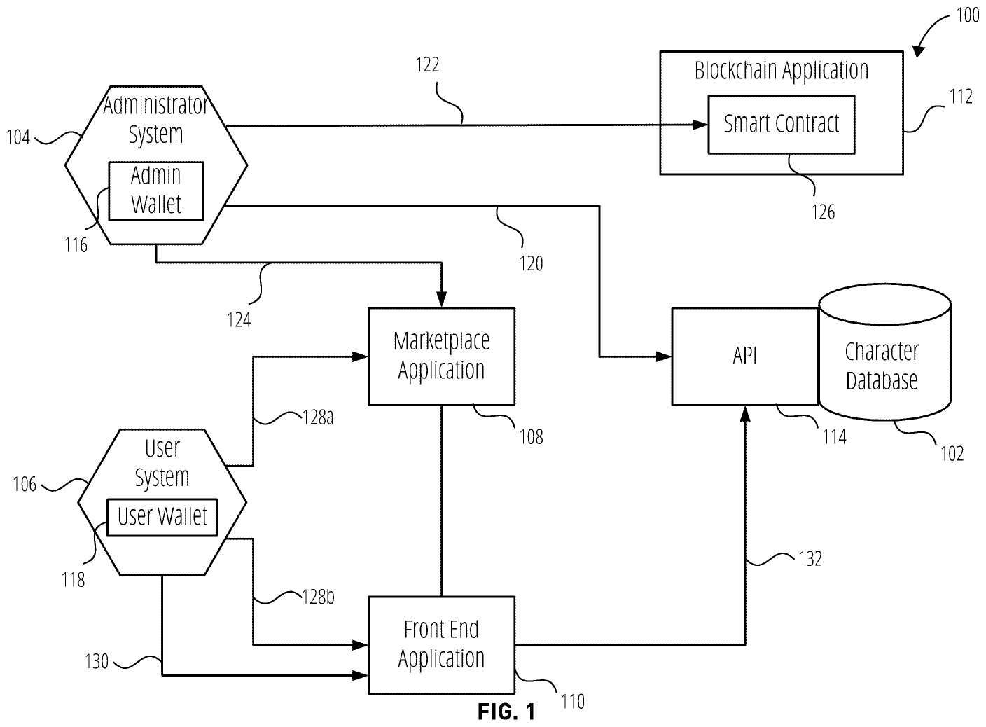

FIG. 1 illustrates a system 100 for the creation and use of video game characters stored in a character database 102, according to embodiments discussed herein. The system 100 includes the character database 102, an administrator computer system 104, a user computer system 106, a marketplace application 108, a front end application 110, and a blockchain application 112. Communication between these elements to be described may occur through the use of one or more network(s) (e.g., the Internet, local area networks (LANs), wide area networks (WANs), etc.) which may be collectively referred to as a single network, consistent with usage of the term “network” herein.

As illustrated, the character database 102 may be accessed externally over the network by other entities of the system 100 through the use of an application programming interface (API) 114. The API 114 may externally expose one or more methods for operating the character database 102 to other entities within the system 100 (e.g., the functions to be described with respect to FIG. 1 may be available through such externally-exposed methods).

The administrator computer system 104 is controlled/operated by an administrator of the character database 102 (and potentially other parts of the system 100, such as, for example, the marketplace application 108 and/or the front end application 110). Various functions described herein with respect to the administrator computer system 104 may thus be understood to be undertaken by such an administrator that is using the administrator computer system 104.

The user computer system 106 is controlled/operated by a user of the system 100 (e.g., where such use corresponds to the operation of user-facing aspects of the character database 102). Various functions described herein with respect to the user computer system 106 may thus be understood to be undertaken by such a user that is using the user computer system 106.

As illustrated, the administrator computer system 104 may own and/or be authorized to control assets corresponding to an administrator wallet 116. Further, as illustrated, the user computer system 106 may own and/or be authorized to control assets corresponding to a user wallet 118.

An example method for the use of the system 100 with respect to characters stored in the character database 102 is now provided. First, the administrator computer system 104 creates 120 one or more new character database entries on the character database 102. In some embodiments, this may be done via a command from the administrator computer system 104 to the API 114 of the character database 102, as illustrated. Each of the character database entries may correspond to a (new, uninitialized) character that is now considered stored at the character database 102.

The administrator computer system 104 mints 122 one or more new character tokens into its administrator wallet 116 via the use of a smart contract 126. These one or more newly-minted character tokens correspond to the one or more new character database entries, such that each (newly-minted) token is associated with one (new, uninitialized) character stored at the character database 102.

As illustrated, the smart contract 126 used for minting 122 the one or more new character tokens may, for example, operate on/with respect to the blockchain application 112, which records and makes publicly available information regarding the wallet/token correspondence between these new character tokens and the administrator wallet 116 in a practically immutable manner. Recordation of such wallet/token correspondence on the blockchain application 112 may engender confidence within the system 100 that the newly minted character tokens are in fact associated with (understood to be owned by) the administrator wallet 116 of the administrator computer system 104.

The administrator computer system 104 then lists 124 the one or more new character tokens on a marketplace application 108. The marketplace application 108 may be a publicly-accessible application such that various external systems (e.g., the user computer system 106) can review data regarding the one or more new character tokens such as price, availability, etc. One example of such a marketplace application 108 may be the OpenSea™ online marketplace for non-fungible tokens (NFTs).

Then, the user computer system 106 either directs 128a to the marketplace application 108 or directs 128b to the front end application 110 to view the available character tokens and to purchase one or more of the character tokens. In the case that the use directs 128b to the front end application 110, the front end application 110 may operate with the marketplace application 108 to display and/or effectuate the purchase of the one or more character tokens.

When a character token is purchased by the user, the marketplace application 108 may interface with the blockchain application 112 to instruct the blockchain application 112 to record a transfer of the ownership/control of the character token from the administrator wallet 116 of the administrator computer system 104 to the user wallet 118 of the user computer system 106. Recordation of such wallet/token correspondence on the blockchain application 112 may engender confidence within the system 100 that the purchased character token is in fact associated with (understood to be owned by) the user wallet 118 of the user computer system 106.

Once the user computer system 106 owns the purchased character token, the user computer system 106 directs 130 to the front end application 110 to perform a user-facing character initialization. While the character associated with the purchased character token exists on the character database 102 (as has been previously described), that character may not yet be initialized to the preferences of the user in at least some cases. Using the front end application 110, the user may, for example, set and/or modify one or more character attributes of the character. To ensure fair/consistent gameplay, the setting and/or modifying of the one or more character attributes of the character may occur within defined bounds (e.g., such that the new character's attributes are consistent with beginning level gameplay/scenarios of the gameplay application that are intended for new characters).

The character attributes as set by the user during character initialization at the system 100 are recorded 132 back to the character database 102. Recordation of these attributes formalizes the character as stored at the character database 102 into an initialized character that is subsequently usable in various different scenarios of a gameplay application intended to provide such scenarios for such characters, as described herein.

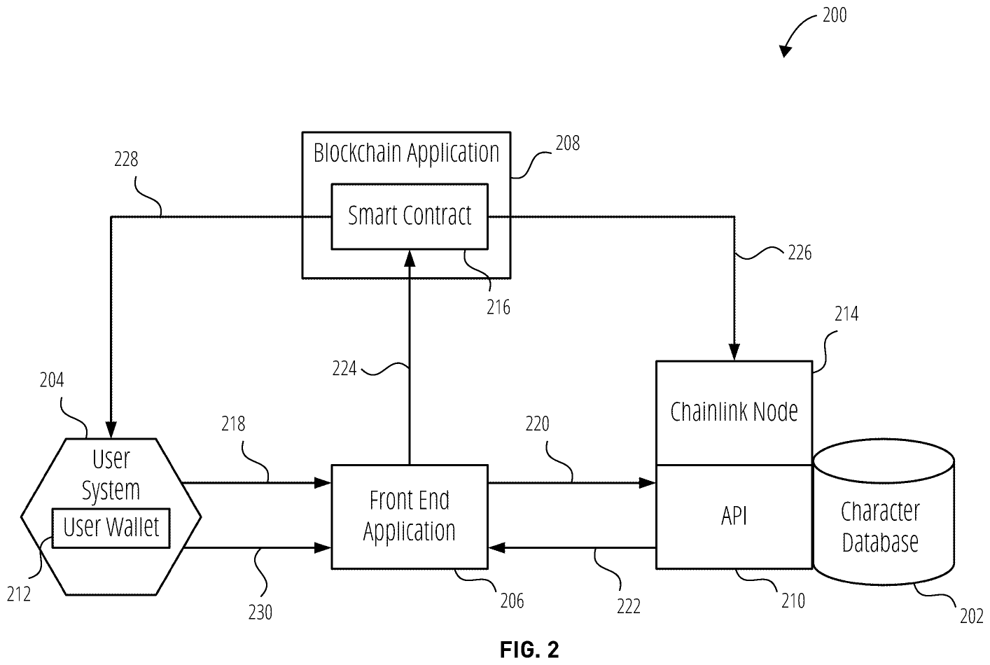

FIG. 2 illustrates a system 200 for the creation and use of video game characters stored in a character database 102, according to embodiments discussed herein. The system 200 includes the character database 202, a user computer system 204, a front end application 206, and a blockchain application 208. Communications between these elements to be described may occur through the network.

As illustrated, the character database 202 may be accessed externally over the network by other entities of the system 200 through the use of an API 210. The API 210 may externally expose one or more methods for operating the character database 202to other entities within the system 200 (e.g., the functions to be described with respect to FIG. 2 may be available through such externally-exposed methods).

It is contemplated that the user computer system 204 is controlled/operated by a user of the system 200 (e.g., where such use corresponds to the operation of user-facing aspects of the character database 202). Various functions described herein with respect to the user computer system 204 may thus be understood to be undertaken by such a user that is using the user computer system 204.

As illustrated, the user computer system 204 may own and/or be authorized to control assets corresponding to a user wallet 212.

An example method for the use of the system 200 with respect to characters stored in the character database 202 is now provided. First, the user computer system 204 directs 218 to the front end application 206 and instructs the front end application 206 that the user wishes to provision a new character.

The front end application 206 sends 220 the character creation request to the API 210 of the character database 202.

The API 210 operates the character database 202 to cause the creation of a new character (e.g., a new database entry for the new character is created). The API 210 then returns 222 a universal resource indicator (URI) for the new character to the front end application 206.

The front end application 206 passes 224 the URI to the blockchain application 208, where it is implemented with/imported into a smart contract 216, as illustrated. The smart contract 216 may be, for example, an Ethereum Request for Comment (ERC) 721 smart contract (in the case that the blockchain application 208 operates an Ethereum blockchain).

The smart contract 216 verifies 226 the character creation of the indicated character has occurred through the chainlink node 214 that operates as a secure interface between the character creation functions of the API 210 and the smart contract 216 and that can ensure consistency of these actions in the event that multiple users are interacting with character creation simultaneously.

After confirming that payment for the new character (and potentially any use fees for the use of the blockchain application 208) has been received, the blockchain application 208 executes 228 the smart contract 216, which causes the character token to be recorded on the blockchain application 208 as owned/operated by the user wallet 212 of the user computer system 204.

At this juncture, the user computer system 204 may then navigate 230 to the front end application 206. Through an interface for the front end application 206 that uses the API 210, the user computer system 204 may operate with the character database 202 to verify its ownership of the newly created character, proceed to initialize the newly created character, request that the newly provided character/attributes of the newly created character be provided to a gameplay application for use by the user computer system 204 in a scenario, etc., as these and similar actions are described herein.

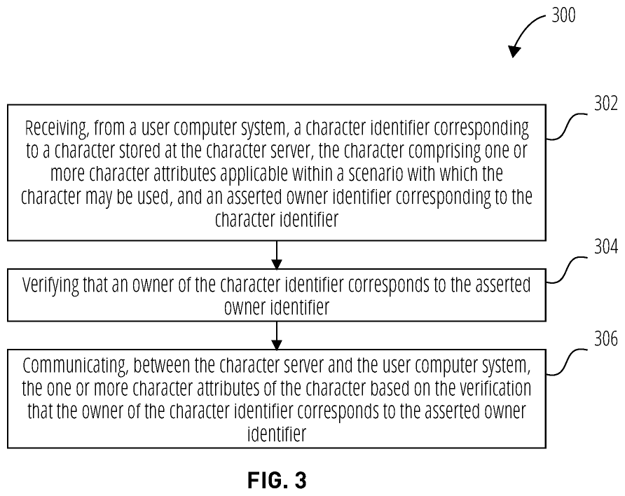

FIG. 3 illustrates a method 300 of a character server, according to embodiments discussed herein. The method 300 includes receiving 302, from a user computer system, a character identifier corresponding to a character stored at the character server, the character comprising one or more character attributes applicable within a scenario with which the character may be used, and an asserted owner identifier corresponding to the character identifier. The method 300 further includes verifying 304 that an owner of the character corresponds to the asserted owner identifier. The method 300 further includes communicating 306, between the character server and the user computer system, the one or more character attributes of the character based on the verification that the owner of the character corresponds to the asserted owner identifier.

In some embodiments of the method 300, the character identifier comprises a character token; the asserted owner identifier comprises an asserted wallet identifier; and the verifying that the owner of the character corresponds to the asserted owner identifier comprises: providing the character token to a blockchain system; receiving a blockchain wallet identifier corresponding to the character token from the blockchain system; and comparing the blockchain wallet identifier to the asserted wallet identifier.

In some embodiments of the method 300, the character identifier comprises a direct indication of the character as provided by the user computer system, the asserted owner identifier comprises user credentials (e.g., a username and/or password) asserted to be for an account that owns/operates the indicated character; and the verifying that the owner of the character corresponds to the asserted owner identifier comprises authenticating the user credentials as corresponding to the account that owns/operates the indicated character.

In some embodiments, the method 300 further includes receiving, from an administrator computer system, an instruction to create the character and store the character at the character server; and creating the character and storing the character at the character server.

In some embodiments, the method 300 further includes receiving, from a service front end system, an instruction to create the character and store the character at the character server; creating the character and storing the character at the character server; and verifying, with a blockchain system, via a chainlink node, that the character has been created.

In some embodiments, the method 300 further includes receiving, from the user computer system, an instruction to communicate the one or more character attributes to a gameplay application operating the scenario; and communicating between the character server and the gameplay application, the one or more character attributes of the character.

In some embodiments of the method 300, the gameplay application is present on the user computer system.

In some embodiments of the method 300, the gameplay application is present on a gameplay computer system that is separate from the user computer system and the character server.

In some embodiments, the method 300 further includes receiving one or more updated character attributes for the character; and updating a corresponding one or more of the one or more character attributes with the one or more updated character attributes.

The method 300 may be used to allow users to create and access their owned/controlled characters, build them up over time via gameplay in first scenario(s), and then use those same characters in different subsequent scenario(s). Conventional gaming solutions do not use character servers to facilitate a streamlined crossing of characters between scenarios in this manner. Further, the use of the character server in this fashion enables the transfer of ownership/control of a character from an original user to a new user in a marketplace, such that effort put into growing character represents a marketable asset of the original user, and/or such that the new user is not necessarily required to spend the necessary time to build the character over time (and can thus immediately use the (already-built) character in scenarios that may anticipate higher-level characters).

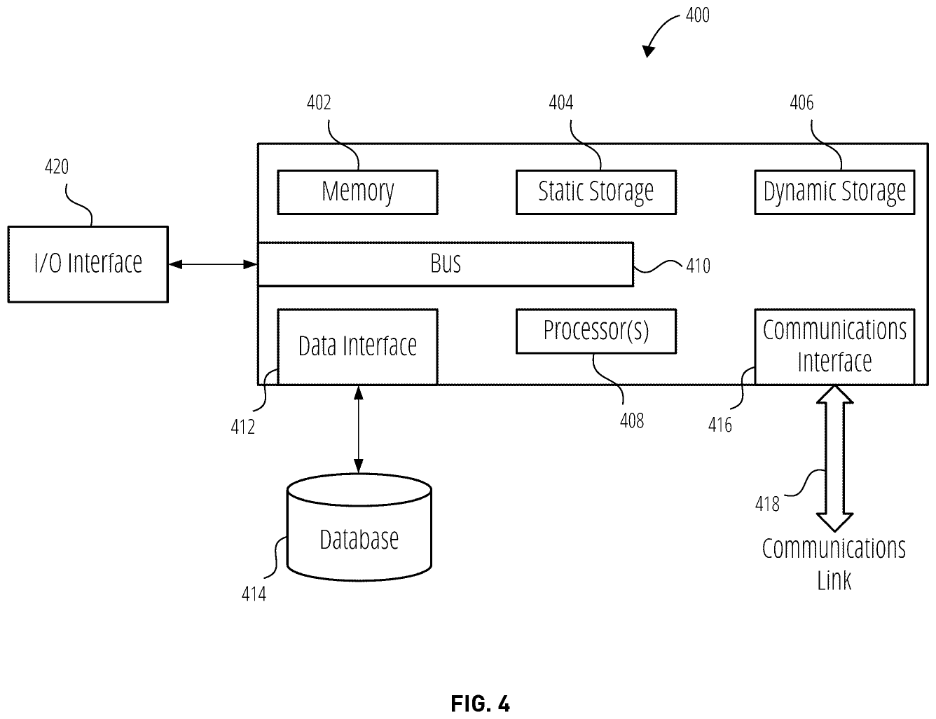

FIG. 4 is a schematic diagram of a computing system 400 which may be used to implement various embodiments in the examples described herein. This disclosure contemplates any suitable number of the computing systems 400. For example, a computing system 400 may be a server, a desktop computing system, a mainframe, a mesh of computing systems, a laptop or notebook computing system, a tablet computing system, or a combination of two or more of these. Where appropriate, the computing system 400 may include one or more computing systems; be unitary or distributed; span multiple locations; span multiple machines; span multiple data centers; or reside in a cloud, which may include one or more cloud components in one or more networks.

The computing system 400 includes a bus 410 (e.g., an address bus and a data bus) or other communication mechanism for communicating information, which interconnects subsystems and devices, such as one or more processors 408, a memory 402 (e.g., random access memory (RAM)), a static storage 404 (e.g., read only memory (ROM)), a dynamic storage 406 (e.g., magnetic or optical), a communications interface 416 (e.g., a modem, an Ethernet card, a network interface controller (NIC) or network adapter for communicating with an Ethernet or other wire-based network, a wireless NIC (WNIC) or wireless adapter for communicating with a wireless network, such as a Wi-Fi™ network, etc.), and/or an input/output (I/O) interface 420 (e.g., a keyboard, a keypad, a mouse, and/or a microphone, etc.). In particular embodiments, a computing system 400 may include one or more of any such components.

In particular embodiments, the one or more processors 408 include hardware for executing instructions, such as those making up a computer program. The one or more processors 408 include circuitry for performing various processing functions, such as executing specific software for performing specific calculations or tasks.

In particular embodiments, the I/O interface 420 includes hardware, software, or both, providing one or more interfaces for communication between the computing system 400 and one or more I/O devices. The computing system 400 may include one or more of these I/O devices, where appropriate. One or more of these I/O devices may enable communication between a person and the computing system 400.

In particular embodiments, the communications interface 416 includes hardware, software, or both providing one or more interfaces for communication (such as, for example, packet-based communication) between the computing system 400 and one or more other computer systems or one or more networks. One or more memory buses (which may each include an address bus and a data bus) may couple the one or more processors 408 to the memory 402. The bus 410 may include one or more memory buses, as described below. In particular embodiments, one or more memory management units (MMUs) reside between the one or more processors 408 and the memory 402 and facilitate accesses to the memory 402 as requested by the one or more processors 408. In particular embodiments, the bus 410 includes hardware, software, or both coupling components of the computing system 400 to each other.

According to particular embodiments, the computing system 400 performs specific operations by the one or more processors 408 executing one or more sequences of one or more instructions contained in the memory 402. Such instructions may be read into the memory 402 from another computer readable/usable medium, such as the static storage 404 or the dynamic storage 406. In alternative embodiments, hard-wired circuitry may be used in place of or in combination with software instructions. Thus, particular embodiments are not limited to any specific combination of hardware circuitry and/or software. In one embodiment, the term “logic” shall mean any combination of software or hardware that is used to implement all or part of particular embodiments disclosed herein.

The term “computer readable medium” or “computer usable medium” as used herein refers to any medium that participates in providing instructions to the one or more processors 408 for execution. Such a medium may take many forms, including but not limited to, nonvolatile media and volatile media. Non-volatile media includes, for example, optical or magnetic disks, such as the static storage 404 or dynamic storage 406. Volatile media includes dynamic memory, such as the memory 402.

The computing system 400 may transmit and receive messages, data, and instructions, including program, e.g., application code, through the communications link 418 and the communications interface 416. Received program code may be executed by the one or more processors 408 as it is received, and/or stored in the static storage 404 or the dynamic storage 406, or other storage for later execution. A database 414 may be used to store data accessible by the computing system 400 by way of the data interface 412.

It is noted that any one or more of the character database, an administrator computer system, a user computer system, a service front end system running a front end application, a marketplace system running a marketplace applications, a blockchain system running a blockchain application, and/or a chainlink node, etc., as these are described herein may be examples of a computing system 400.

Note that while various examples herein are provided in the context of a scenario operated by a gameplay application, the methodologies described herein regarding the use, storage, retrieval, growth, and/or proof of ownership of a character through the use of the character server may also be applied with respect to characters for compatible scenarios that are operated manually (e.g., an in-person tabletop scenario). This may be so no matter whether such manual scenarios are used with the character either instead of, or in addition to, other scenarios that are operated by the gameplay application.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense.

From the foregoing it will be appreciated that, although specific embodiments have been described herein for purposes of illustration, various modifications may be made without deviating from the spirit and scope of the invention.

The particulars shown herein are by way of example and for purposes of illustrative discussion only and are presented in the cause of providing what is believed to be the most useful and readily understood description of the principles and conceptual aspects of various embodiments. In this regard, no attempt is made to show structural details in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A method of a character server, comprising:
receiving, from a user computer system:
a character identifier corresponding to a character stored at the character server, the character comprising one or more character attributes applicable within a scenario with which the character may be used; and
an asserted owner identifier corresponding to the character identifier;
verifying that an owner of the character corresponds to the asserted owner identifier; and
communicating, between the character server and the user computer system, the one or more character attributes of the character based on the verification that the owner of the character corresponds to the asserted owner identifier.

2. The method of claim 1, wherein:
the character identifier comprises a character token;
the asserted owner identifier comprises an asserted wallet identifier; and
wherein the verifying that the owner of the character corresponds to the asserted owner identifier comprises:
providing the character token to a blockchain system;
receiving a blockchain wallet identifier corresponding to the character token from the blockchain system; and
comparing the blockchain wallet identifier to the asserted wallet identifier.

3. The method of claim 1, further comprising:
receiving, from an administrator computer system, an instruction to create the character and store the character at the character server; and
creating the character and storing the character at the character server.

4. The method of claim 1, further comprising:
receiving, from a service front end system, an instruction to create the character and store the character at the character server;
creating the character and storing the character at the character server; and
verifying, with a blockchain system, via a chainlink node, that the character has been created.

5. The method of claim 1, further comprising:
receiving, from the user computer system, an instruction to communicate the one or more character attributes to a gameplay application operating the scenario; and
communicating between the character server and the gameplay application, the one or more character attributes of the character.

6. The method of claim 5, wherein the gameplay application is present on the user computer system.

7. The method of claim 5, wherein the gameplay application is present on a gameplay computer system that is separate from the user computer system and the character server.

8. A computing apparatus of a character server, comprising:
one or more processors; and
a memory storing instructions that, when executed by the one or more processors, configure the character server to:
receive, from a user computer system:
a character identifier corresponding to a character stored at the character server, the character comprising one or more character attributes applicable within a scenario with which the character may be used; and
an asserted owner identifier corresponding to the character identifier;
verify that an owner of the character corresponds to the asserted owner identifier; and
communicate, between the character server and the user computer system, the one or more character attributes of the character based on the verification that the owner of the character corresponds to the asserted owner identifier.

9. The computing apparatus of claim 8, wherein:
the character identifier comprises a character token;
the asserted owner identifier comprises an asserted wallet identifier; and
wherein the verifying that the owner of the character corresponds to the asserted owner identifier comprises:
providing the character token to a blockchain system;
receiving a blockchain wallet identifier corresponding to the character token from the blockchain system; and
comparing the blockchain wallet identifier to the asserted wallet identifier.

10. The computing apparatus of claim 8, wherein the instructions, when executed by the one or more processors, further configure the character server to:
receive, from an administrator computer system, an instruction to create the character and store the character at the character server; and
create the character and store the character at the character server.

11. The computing apparatus of claim 8, wherein the instructions, when executed by the one or more processors, further configure the character server to:
receive, from a service front end system, an instruction to create the character and store the character at the character server;
create the character and storing the character at the character server; and
verify, with a blockchain system, via a chainlink node, that the character has been created.

12. The computing apparatus of claim 8, wherein the instructions, when executed by the one or more processors, further configure the character server to:
receive, from the user computer system, an instruction to communicate the one or more character attributes to a gameplay application operating the scenario; and
communicate, between the character server and the gameplay application, the one or more character attributes of the character.

13. The computing apparatus of claim 12, wherein the gameplay application is present on the user computer system.

14. The computing apparatus of claim 12, wherein the gameplay application is present on a gameplay computer system that is separate from the user computer system and the character server.

15. A non-transitory computer-readable storage medium having instructions that, when executed by a one or more processors of a character server, cause the character server to:
receive, from a user computer system:
a character identifier corresponding to a character stored at the character server, the character comprising one or more character attributes applicable within a scenario with which the character may be used; and
an asserted owner identifier corresponding to the character identifier;
verify that an owner of the character corresponds to the asserted owner identifier; and
communicate, between the character server and the user computer system, the one or more character attributes of the character based on the verification that the owner of the character corresponds to the asserted owner identifier.

16. The non-transitory computer-readable storage medium of claim 15, wherein:
the character identifier comprises a character token;
the asserted owner identifier comprises an asserted wallet identifier; and
wherein the verifying that the owner of the character corresponds to the asserted owner identifier comprises:
providing the character token to a blockchain system;
receiving a blockchain wallet identifier corresponding to the character token from the blockchain system; and
comparing the blockchain wallet identifier to the asserted wallet identifier.

17. The non-transitory computer-readable storage medium of claim 15, wherein the instructions, when executed by the one or more processors, further configure the character server to:
receive, from an administrator computer system, an instruction to create the character and store the character at the character server; and
create the character and storing the character at the character server.

18. The non-transitory computer-readable storage medium of claim 15, wherein the instructions, when executed by the one or more processors, further configure the character server to:
receive, from a service front end system, an instruction to create the character and store the character at the character server;
create the character and storing the character at the character server; and
verify, with a blockchain system, via a chainlink node, that the character has been created.

19. The non-transitory computer-readable storage medium of claim 15, wherein the instructions, when executed by the one or more processors, further configure the character server to:
receive, from the user computer system, an instruction to communicate the one or more character attributes to a gameplay application operating the scenario; and
communicate between the character server and the gameplay application, the one or more character attributes of the character.

20. The non-transitory computer-readable storage medium of claim 19, wherein the gameplay application is present on the user computer system.

21. The non-transitory computer-readable storage medium of claim 19, wherein the gameplay application is present on a gameplay computer system that is separate from the user computer system and the character server.
